(19) United States
(12) Patent Application Publication
(10) Pub. No.: US 2011/0137573 A1
(43) Pub. Date: Jun. 9, 2011

(54) SYSTEM AND METHOD FOR MONITORING EMISSIONS FROM ENGINES

(76) Inventor: LINCOLN EVANS-BEAUCHAMP, Palo Alto, CA (US)

(21) Appl. No.: 12/700,179

(22) Filed: Feb. 4, 2010

Related U.S. Application Data
(60) Provisional application No. 61/286,018, filed on Dec. 14, 2009.
(60) Provisional application No. 61/266,516, filed on Dec. 4, 2009.

(51) Int. Cl. G01M 15/10; F02B 27/04; G06F 19/00

(52) U.S. Cl. 702/24; 60/273; 702/113

(57) ABSTRACT

A system is provided for monitoring and testing engine emissions during normal operations. The system monitors and logs engine data to determine when the engine is operating at a steady-state within a defined test mode. The system may measure and log multiple sets of emissions data while the engine is operating in the defined test mode. The multiple sets of emissions data may be aggregated for qualifying the engine and may provide trend information about the engine. The test mode definition may be revised based on the logged engine data. The system may be used to selectively monitor one or more of a set of multiple engines.

### CROSS-REFERENCE TO RELATED APPLICATIONS

The present application claims the priority and benefit of U.S. patent application No. 61/286,018 titled “Emissions Control System,” filed Dec. 14, 2009 and U.S. patent application No. 61/266,516 titled “Engine Emission Control,” filed Dec. 4, 2009. The disclosures of all of the above U.S. patent applications are incorporated by reference herein in their entirety.

### BACKGROUND

1. Field of the Invention

The present disclosure generally relates to emission control systems. The present disclosure more specifically relates to monitoring and sampling emissions from an engine for testing during operation.

2. Description of Related Art

Emissions and emissions control systems on ship engines must be tested periodically. Authorities such as US Environmental Protection Agency (EPA) and British Standards Institute (BSI) specify testing protocols for ship engines. Tested emissions include Oxygen (O₂), Hydrocarbons (HC), Non-methane hydrocarbons (NMHC), Oxides of nitrogen (NOx), Sulfur dioxide (SO₂), Ammonia (NH₃), Dinitrogen oxide (N₂O), Formaldehyde (HCHO), Methanol (CH₃OH), particulate matter (PM), and oxides of carbon (COₓ) (e.g., Carbon monoxide (CO), Carbon dioxide (CO₂), etc.). Engine operating conditions are measured during testing. Measured engine parameters include speed, engine (RPM), torque, power, temperature, fuel flow or consumption, air flow or consumption, and exhaust gas flow, engine intake air temperature and pressure, and exhaust gas temperature and pressure.

Particulate materials comprise primarily carbon, condensed hydrocarbons, and sulfates and associated water. Particulate collection and measurement methods may reflect legal requirements (e.g., in the USA and European Union). For example, regulations may require particulate material in exhaust gases to be collected on a specified filter medium after diluting the exhaust gases using clean, filtered air to a specified temperature range as measured at a point upstream of a primary filter.

Emissions control tests typically include a collection of data during steady-state test cycles or profiles. The profiles are designed for various classes of engines and equipment. Each of these test profiles represent a sequence of one or more test modes and steady-states during which emissions are measured. A weighting factor may be applied to emissions measurements for each mode. A test mode for an engine operation is defined in a test profile as an area on an engine speed-power map. The test profile may define a steady-state for a test mode as operating the engine for a set period of time (e.g., six minutes) within the test mode.

FIG. 1A is a speed-power map 100 for an engine, according to prior art. The horizontal axis of FIG. 1A represents percent rated speed of an engine and the vertical axis represents percent rated power of the engine. The speed-power map 100 includes a power curve 110 for the engine. Line A-B of the power curve 110 illustrates maximum rated power for the engine. The maximum rated power (rated power) for an engine is a maximum continuous power to be used with the engine. The rated power is typically set somewhat lower than the maximum available power from the engine. Line B-C illustrates the maximum rated speed of the engine. The maximum rated speed (rated speed) for an engine is a maximum continuous speed at which to operate the engine. The rated speed is typically set somewhat lower than the maximum speed the engine can achieve. Line C-D illustrates idling power over a range of speeds. Line D-E illustrates minimum speed for operating the engine. Line E-A illustrates maximum torque for the engine.

The speed-power map 100 of FIG. 1A includes test modes 1-4. Test modes 1-4 are represented by an area of the speed-power map 100. The area representing test mode 1 includes 95-105% rated speed, which is a target speed of 100% plus or minus 5% of the rated speed. The area also includes 95-105% rated power for an engine, which is a target power of 100% plus or minus 5% of the rated power. Thus, in test mode 1, the engine is run at about 100% rated speed and 100% rated power. In test mode 2 the engine is run at a target of about 91% rated speed and 75% rated power. In test mode 3, the engine is run at a target of about 80% rated speed and 50% rated power. In test mode 4, the engine is run at a target of about 63% rated speed and 25% rated power, at that speed. The rated power at 63% speed in FIG. 1A may be represented by point F along the maximum torque line E-A. The area representing each of the test modes 1-4 of FIG. 1A includes plus or minus 5% of the target speed and power. However, a larger or smaller area may be specified about each test mode on the speed-power map 100.

FIG. 1B illustrates a test profile 120 for the speed-power map 100 of FIG. 1, according to prior art. The horizontal axis of FIG. 1B represents time and the vertical axis represents percent rated power. The test profile 120 illustrates an emissions testing sequence of settings and times for collecting emission data in test modes 1-4 during a steady-state in each mode. The test profile 120 specifies that the engine is to be operated in each test mode for six minutes and that emission data is to be collected during the final three minutes of each test mode. Transitions between test modes are made over a short period of time, as quickly as practicable.

The test profile 120 of FIG. 1B illustrates transitioning power and speed from about 0% to the full power of test mode 1. Test mode 1 is then maintained at a steady-state for a period of time specified by test profile 120. Test mode 1 illustrated in FIG. 1B has a duration of six minutes and emission data 1 is collected during the final three minutes of the test mode 1. The test profile 120 further specifies that after operating the engine in test mode 1 for six minutes the engine is transitioned to test mode 2 where it is operated for six minutes, then transitioned to test mode 3 where it is operated for six minutes, and then transitioned to test mode 4 where it is operated for six minutes. The test profile further specifies that emission data 2, 3, and 4 are collected during the final three minutes of the six minute steady-state in test modes 2, 3 and 4, respectively. A weight W₁, W₂, W₃, and W₄ is applied to each of emission data 1, data 2, data 3, and data 4, respectively, according to the equation:

E=data1*W₁+data1*W₂+data1*W₃+data1*W₄

where E is a total emission number E that is calculated from a sum of the weighted data.

Speed-power maps, test modes, and test profiles are further described in ISO 8178 which is incorporated by reference herein in its entirety. The steady-state test modes such as those illustrated in FIGS. 1A and 1B and ISO documents are selected to represent a standard usage expected for an engine.

Unfortunately, many engines are normally operated during a majority of the time in one or more modes that are not represented by any of the test modes in any of the standard test profiles. Thus, emissions data do not accurately reflect actual emissions produced by many engines during normal operation.

### SUMMARY OF THE CLAIMED INVENTION

In an embodiment of the presently claimed invention, a system is provided for monitoring exhaust emissions. The system monitors engine parameters during normal operations to determine if the engine is in a steady-state and operating within a test mode. The test mode may be defined by the engine parameters and a period of time in a steady-state. The system may measure exhaust emissions while the engine is operating in the test mode. The system may suspend emissions measurements while the engine is not in the test mode. The system may measure and log multiple sets of emissions data for during normal operations within the defined test mode. The multiple sets of emissions data may be aggregated for qualifying the engine for use. The multiple data sets may also provide trend information about the engine. The multiple data sets may further be used to revise the test mode definition to more accurately reflect the total emissions and use of the engine. The system may be used to selectively monitor and/or measure one or more of multiple engines.

In an embodiment of the presently claimed invention, a method is provided for monitoring emissions from an engine onboard a ship. The method includes monitoring engine data using a computer system and storing the monitored engine data in the computer system. The method further includes using the computer system to determine if the engine is operating in a steady-state based on the stored engine data. The computer also compares the monitored engine data with a test mode definition in a test profile database to determine if the engine is operating within a test mode. An emissions detector is fluidly connected to the engine exhaust gas based on the steady-state determination and the test mode determination. The coupled emissions detector is activated based on the test profile data while the engine is operating within the test mode. The computer system receives and stores emissions data from the activated emissions detector. The received data represents emissions in the engine exhaust gas during the steady-state. The method further includes updating the test mode definition in the test profile database based on the monitored engine data. The method also includes performing the steps of determining if the engine is operating in a steady state and test mode, comparing engine data with the test mode definition, and receiving and storing emissions data multiple times during normal operation.

In an embodiment of the presently claimed invention, a system is provided for monitoring engine exhaust gas emissions. The system includes an engine monitor configured to receive a stream of engine data from engine sensors during normal operations of the engine, and an engine data log configured to store the stream of engine data. The system further includes an emissions detector module under computer control that is configured for fluid coupling and un-coupling to the engine exhaust gas. The emissions detector module includes sensors configured for measuring the engine exhaust gas emissions. The system further includes an emissions data log and a test profile database. The emissions data log stores measured emissions data from the emissions detector module. The test profile database is stores an emission test profile and a test mode definition. The system also includes a computer system coupled to the engine monitor and the emissions detector module. The computer system is configured to determine if the engine is in a steady-state based on the stream of engine data and if the engine is operating within the test mode based on a comparison of the test mode definition to the stream of engine data. The computer system couples the emissions detector module to the engine exhaust gas for execution of the emission test profile when the engine is operating within the test mode. The computer system is also configured to modify the test mode definition in the test profile database using the stream of engine data.

In an embodiment of the presently claimed invention, an emission detector system is provided for monitoring engine exhaust gas emissions onboard a ship. The system includes a computer system that is configured to control a valve, a heater, a compressor, an orifice array, an emissions detector, and an accelerometer. The valve is configured to couple the emissions detector system selectively to exhaust gas from either a first engine or a second engine. The heater is configured to heat the engine exhaust gas. The compressor is configured to provide the exhaust gas at a target pressure to the orifice array, which controls the flow rate of a stream of exhaust gas to the emissions detector. The emissions sensor is configured to measure emissions in the exhaust gas received from the orifice array. The accelerometer is configured to detect motion of the emissions detector system. The computer system is configured to suspend measurements of emissions based on detection of excessive acceleration of the emissions detector system. The emissions sensor may be an O₂ sensor configured to measure oxygen, a HC sensor configured to measure hydrocarbons, a PM sensor configured to measure particulate matter, or a COx sensor configured to measure oxides of carbon such as CO, CO₂, and etc.

### BRIEF DESCRIPTION OF THE DRAWINGS

FIG. 1A is a speed-power map for an engine illustrating a test profile, according to prior art.

FIG. 1B illustrates a test profile for the speed-power map of FIG. 1A, according to prior art.

FIGS. 2A-2C are block diagrams illustrating prior art configurations of engine systems for use in a ship, according to prior art.

FIG. 3 is a block diagram illustrating a system for monitoring emissions from engines according to aspects of the invention.

FIG. 4 is a block diagram illustrating details of an emissions detector module of FIG. 3.

FIG. 5 is a block diagram illustrating details of a computer system of FIG. 3.

FIG. 6 is a flow diagram of an exemplary process for monitoring emissions from an engine.

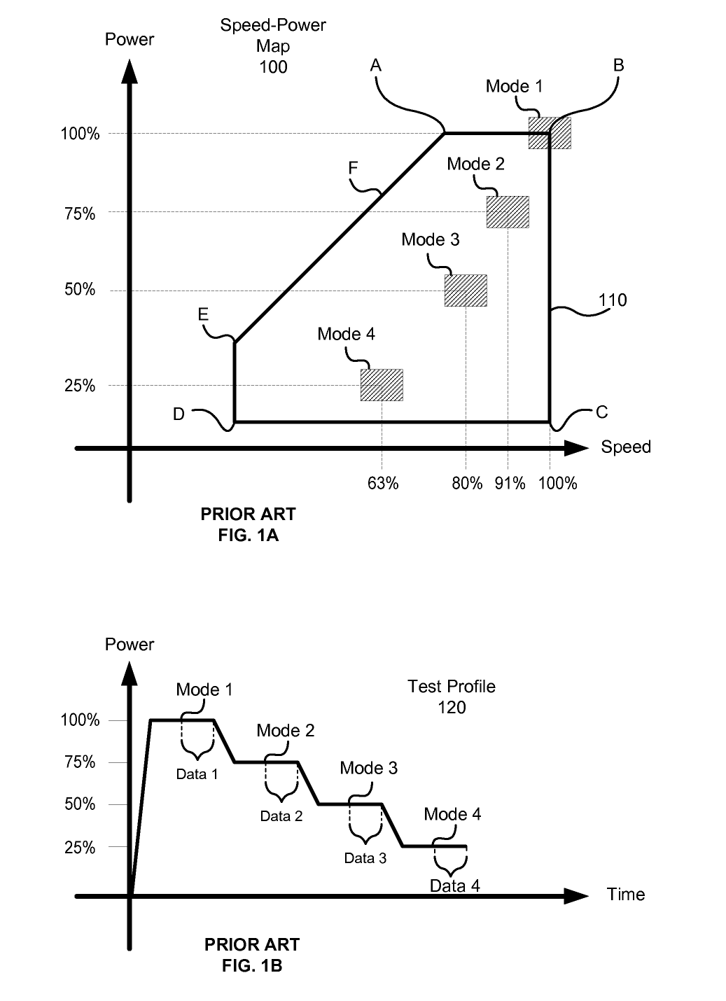

### DETAILED DESCRIPTION

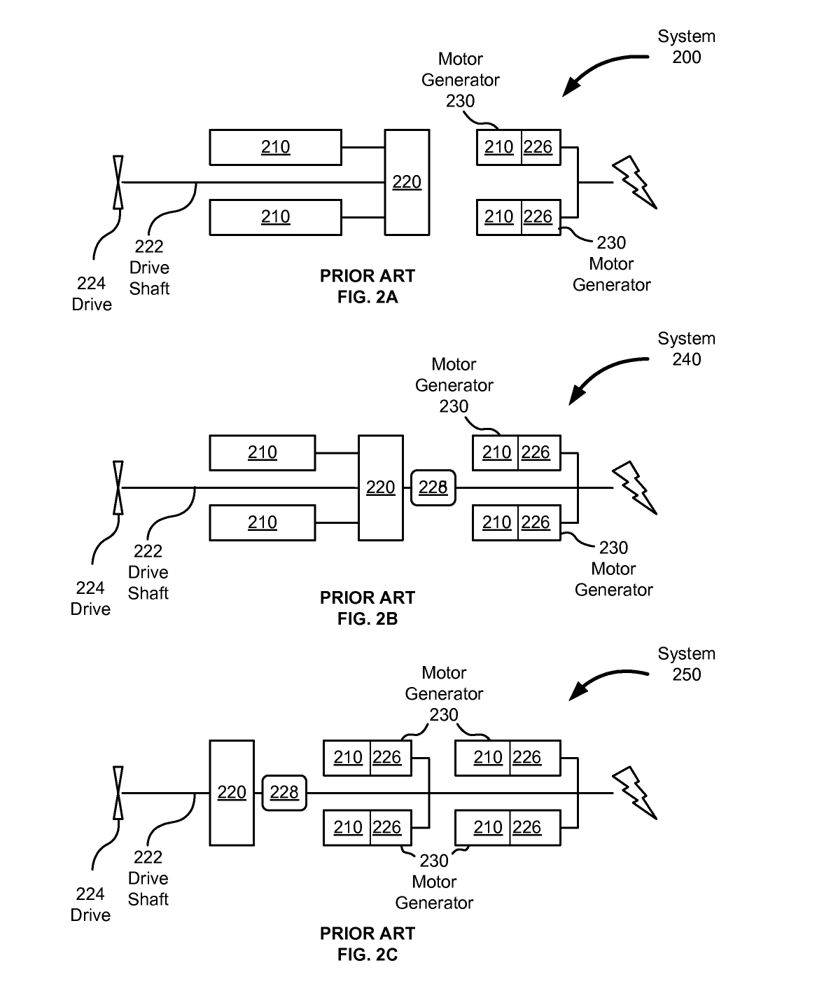

FIGS. 2A-2C are block diagrams illustrating prior art configurations of engine systems 200, 240, and 250 for use in a ship. FIG. 2A is a block diagram illustrating engine system 200. Engine system 200 includes engines 210 and a transmission 220. One engine 210 may be idled or shut down while the other engine 210 provides power, for example, when power from only one engine 210 is required. The transmission 220 may couple power from the engines 210 to a driveshaft 222 to turn a drive 224. Examples of the drive 224 include a propeller, a turbine a jet, etc. The transmission 220 may couple power from either or both engines 210. In some embodiments, each engine 210 includes a separate transmission 220, driveshaft 222 and drive 224. The transmission 220 typically includes a reduction gear. While the engine system 200 illustrates two engines 210 coupled to the transmission 220, fewer or more engines 210 may coupled to the transmission 220 in the engine system 200.

The engine system 200 further includes motor-generators 230. Each motor-generator 230 includes an engine 210 configured to drive a generator 226. The generator 226 may produce electricity for use in ship systems such as lights, instruments, actuators, environmental controls, etc. The motor-generators 230 illustrated in the engine system 200 are independent of the engines 210 coupled to the transmission 220. One motor-generator 230 may be run at idle or shut down while the other motor-generator 230 provides power, for example, when power from only one motor-generator 230 is required. While the system 200 illustrates two motor-generators 230 fewer or more motor-generators 230 may used in the system 200.

FIG. 2B is a block diagram illustrating engine system 240. The engine system 240 differs from the engine system 200 in that the generators 226 of the motor-generators 230 are configured to provide electric power to an electric motor 228 which converts electric power from the motor-generators 230 to mechanical power. The electric motor 228 of system 240 is mechanically coupled to the transmission 220. Either or both of the motor-generators 230 may be coupled to the electric motor 228 using a switching system (not illustrated). Engine systems 200 and 240 may be considered hybrid systems in that they use separate engines for producing mechanical power and electrical power. While the system 240 illustrates two engines 210 configured to mechanically drive the transmission 220 and two motor-generators 230 fewer or more engines 210 and/or motor-generators 230 may used in the system 200.

FIG. 2C is a block diagram illustrating engine system 250. The engine system 250 differs from the engine system 240 in that the engine system 250 includes only motor-generators 230. Power to the transmission is provided entirely from the motor-generators 230 via the electric motor 228. One or more motor-generator 230 may be idled or shut down while the remaining motor-generators 230 provide power. More than one electric motor 228 may be coupled to the motor-generators 230. For example, each motor-generator 230 may be coupled to a separate electric motor 228 which is, in turn, mechanically coupled to one or more transmission 220. While the system 250 illustrates four motor-generators 230, fewer or more motor-generators 230 may used in the system 200.

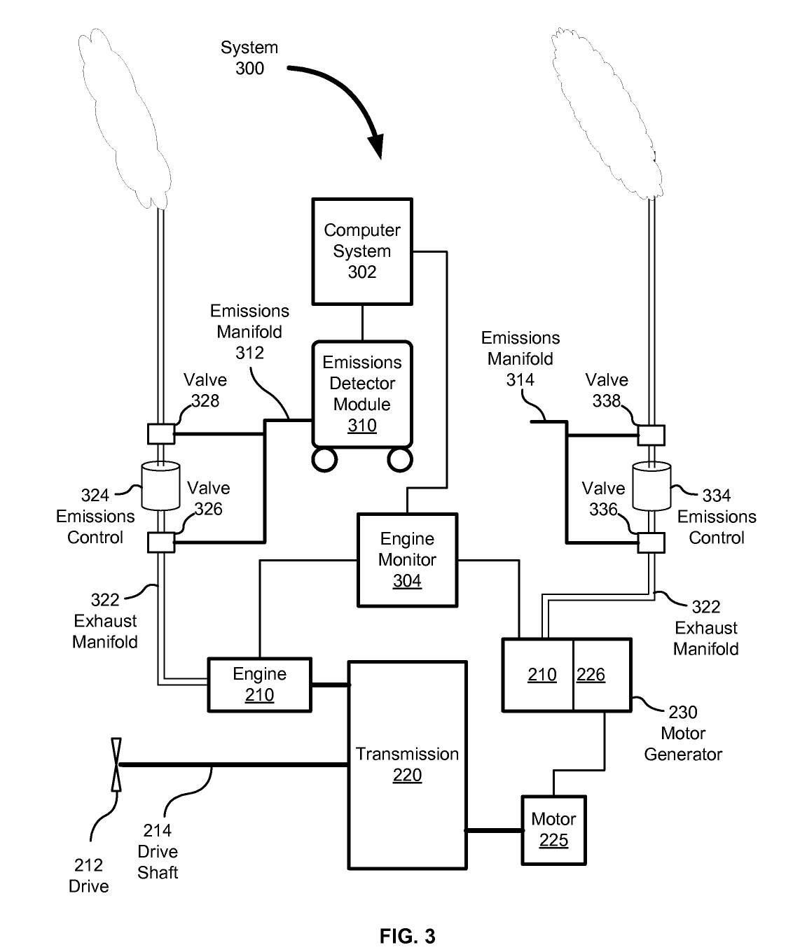

FIG. 3 is a block diagram illustrating a system 300 for monitoring emissions from one or more engines 210, according to aspects of the invention. The engines 210 of FIG. 3 may be used, for example, in the configurations of engine systems 200, 240, and 250. System 300 includes a computer system 302 in communication with an engine monitor 304 and an emissions detector module 310. The engines 210 of FIG. 3 include internal combustion engines, external combustion engines, reciprocating, rotary, diesel, gas, steam, stirling, turbine engines, hybrid cycle, separate cycle, and combined cycle engines.

The engine monitor 304 may be coupled to one or more engines 210 and/or generators 226 and configured to receive data representing operation of the engine 210. The received data includes speed, RPM, torque, power, temperature, fuel flow or consumption, air flow or consumption, exhaust gas flow, engine intake air temperature and pressure, exhaust gas temperature and pressure. Power can be derived from RPM and Torque. Power data may be measured in the form of electrical power generated by the motor generator 230. Optionally, the engine monitor 304 receives data from accelerometers coupled to the engine 210, exhaust manifold 322, emissions control 324, emissions control 334, generator 226, and/or ship. The accelerometer data may be used to determine acceleration associated with impact, motion, vibration, and shaking, due to maneuvering, wave action, storms, and etc. The accelerometer data may be used for determining if the engines 210 are in a steady-state.

The emissions detector module 310 is configured for being selectively coupled to an emissions manifold 312 and/or emissions manifold 314. The emissions manifold 312 may be coupled to a valve 328 and/or 326 for receiving exhaust gas from the engine 210. The valve 326 is configured to direct exhaust gas sampled upstream of an emissions control device 324 into the emissions manifold 312. The valve 328 is configured to direct exhaust gas sampled downstream of the emissions control device 324 into the emissions manifold 312. The valves 326 and/or 328 may be controlled using the computer system 302.

Similarly, the emissions manifold 314 may be coupled to a valve 338 and/or 336 for receiving exhaust gas from the engine 210 of the motor-generator 230. The valve 336 is configured to direct exhaust gas sampled upstream of an emissions control device 334 into the emissions manifold 314. The valve 338 is configured to direct exhaust gas sampled downstream of the emissions control device 334 into the emissions manifold 314. The valves 336 and/or 338 may be controlled using the computer system 302. Thus, the emissions detector module 310 may be configured to sample exhaust gas from one or more engine 210.

The emissions detector module 310 may be physically moved between multiple engines 210. For example emissions detector module 310 of FIG. 3 may be physically moved from a physical connection at the emissions manifold 314 at the engine 210 of the motor-generator 230 to another engine 210 for connection to the emissions manifold 312. Alternatively, the emissions detector module 310 may be coupled to both the emissions manifold 312 and 314 at the same time.

While two engines 210 are illustrated in FIG. 3, the engine monitor 304 may be configured to monitor more or fewer engines 210. Similarly, the emissions detector module 310 may be configured to sample exhaust from more or fewer engines 210.

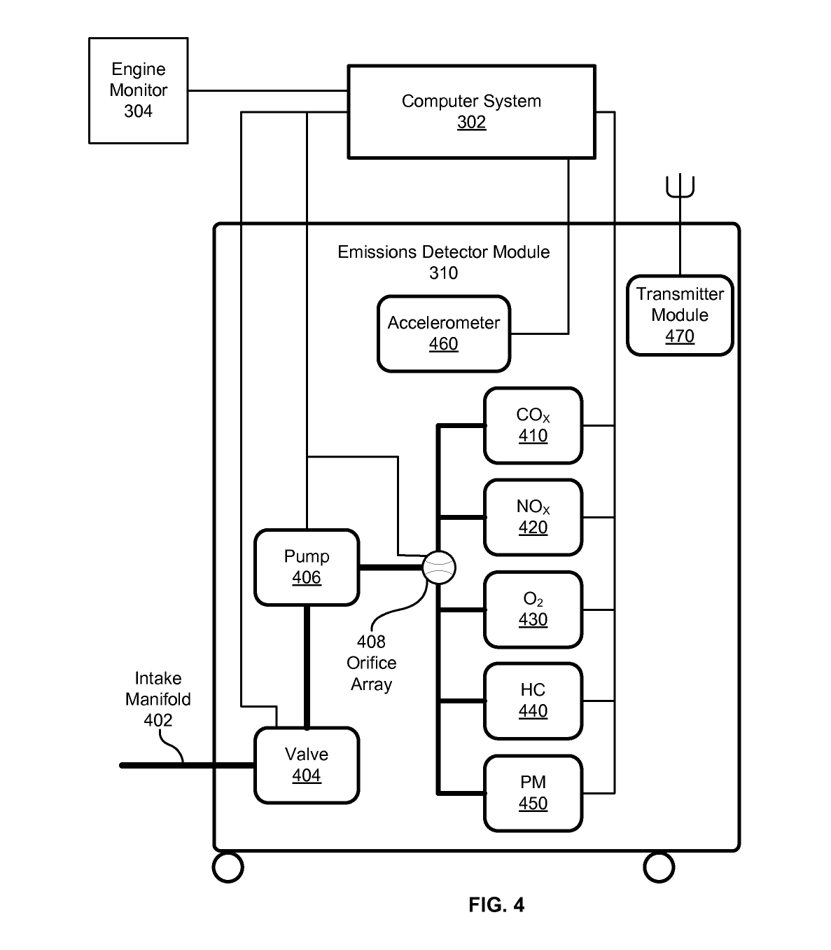

FIG. 4 is a block diagram illustrating details of the emissions detector module 310 of FIG. 3. The emissions detector module 310 includes an intake manifold 402 and a valve 404. The intake manifold 402 is configured for coupling to one or more emissions manifold such as emissions manifold 312 and 314. The intake manifold 402 may be heated for maintaining the exhaust gas at a desired temperature.

The valve 404 may be used for isolating the emissions detector module 310 when not in use or during repositioning. The emissions detector module 310 may be portable for physically moving between emissions manifold 312 and 314. For example, upon determining that the engine 210 coupled to the transmission 220 is operating in a steady-state test mode, the emissions detector module 310 may be repositioned and connected to the emissions manifold 312 for collection of emissions data. Similarly, upon determining that the engine 210 in the motor generator 230 is operating in a steady-state test mode, the emissions detector module 310 may be repositioned and connected to the emissions manifold 314. The intake manifold 402, emissions manifold 312, and emissions manifold 314 may be fitted with quick disconnect fittings for ease of connecting and disconnecting. The valve 404 may isolate the intake manifold 402 while the manifold 402 is disconnected during repositioning of the emissions detector module 310.

Alternatively, the intake manifold may be connected to both the emissions manifold 312 and 314. The valve 404 may be configured for selecting between the emissions manifolds 312 and 314. The valve 404 of FIG. 4 is under control of the computer system 302 for isolating the emissions detector module 310 and/or selectively admitting exhaust gas from emissions manifold 312 and/or 314.

The emissions detector module 310 of FIG. 4 further includes a COx detector 410, a NOx detector 420, an 02 detector 430, a HC detector 440, and a PM detector 450 (emissions detectors 410-450). The emissions detectors 410-450 are communication with the computer system 302. The emissions detectors 410-450 are representative of various detectors that may be used in the emissions detector module 310. One or more of the emissions detectors 410-450 may be omitted. Alternatively, one or more additional detectors (e.g., NMHC, SO₂, NH₃, N₂O, HCHO, CH₃OH, and etc.) may be used in place of and/or in addition to the emissions detectors 410-450.

The emissions detector module 310 of FIG. 4 further includes a pump 406 and an orifice array 408. The pump 406 may include a compressor and is configured for maintaining the exhaust gas at a target pressure and flow to the orifice array 408. The pump 406 may include a heater for maintaining the exhaust gas at a target temperature for analysis by the emissions detectors 410-450. The computer system 302 may control the pump 406 and/or heater to achieve a set point for the target pressure, flow and/or temperature of the exhaust gas to the orifice array 408.

The orifice array 408 includes one or more apertures or nozzles configured to receive exhaust gas from the pump 406 and meter or control the exhaust gas to the emissions detectors 410-450. Each aperture in the orifice array 408 may be sized to control the flow of the exhaust gas to one or more of the emissions detectors 410-450 at a given pressure maintained by the pump 406. For example, a first aperture in the orifice array 408 may be in fluid communication with the COx detector 410, a second aperture in fluid communication with the NOx detector 420, and a third aperture in fluid communication with three detectors, namely the 02 detector 430, the HC detector 440, and the PM detector 450. At a pressure of 1.3 atmospheres maintained by the pump 406, the first aperture may restrict the flow of exhaust gas to a rate of 10 ml per minute, the second aperture may restrict the flow of exhaust gas to 5 ml per minute, and the third aperture may restrict the flow of exhaust gas to 100 ml per minute. Optionally, one or more of the apertures in the orifice array 408 includes a valve (not illustrated) configured to isolate or block flow of the exhaust gas through the aperture.

The emissions detector module 310 of FIG. 4 further includes an accelerometer 460. The accelerometer 460 is configured to provide data to the computer system 302 representing acceleration and/or oscillation of the emissions detector module 310. The computer system 302 may use the data to determine if the emissions detector module 310 is subject to impact, motion, vibration, and shaking, due to maneuvering, storms, heavy seas, or waves. Excessive acceleration may result in inaccurate measurements by the emissions detectors 410-450. For example, particulate matter may be dislodged from the insides of various parts such as manifolds, tubing, ducts, orifices, and valves within the emissions detector module 310, thus, resulting in abnormally high particle measurements.

The emissions detector module 310 includes an optional transmitter module 470. The transmitter module 470 may provide communication between the emissions detector module 310 and the computer system 302 and/or the engine monitor 304. In some embodiments, one or more of the emissions detectors 410-450 are located external to the emissions detector module 310 (e.g., on the engine 210, the manifold 322, and/or the emissions control system 324). The transmitter module 470 may provide communication between the emissions detector module 310 and the one or more externally located emissions detectors 410-450. The transmitter module 470 may also provide communication between the emissions detector module 310 and sensors configured to transmit data representing operation of the engine 210. Various modes of communication via the transmitter module 470 include wireless, infrared, intranet, internet, satellite, LAN, WAN, optical fiber, cell, ship to shore, ship to ship, and etc.

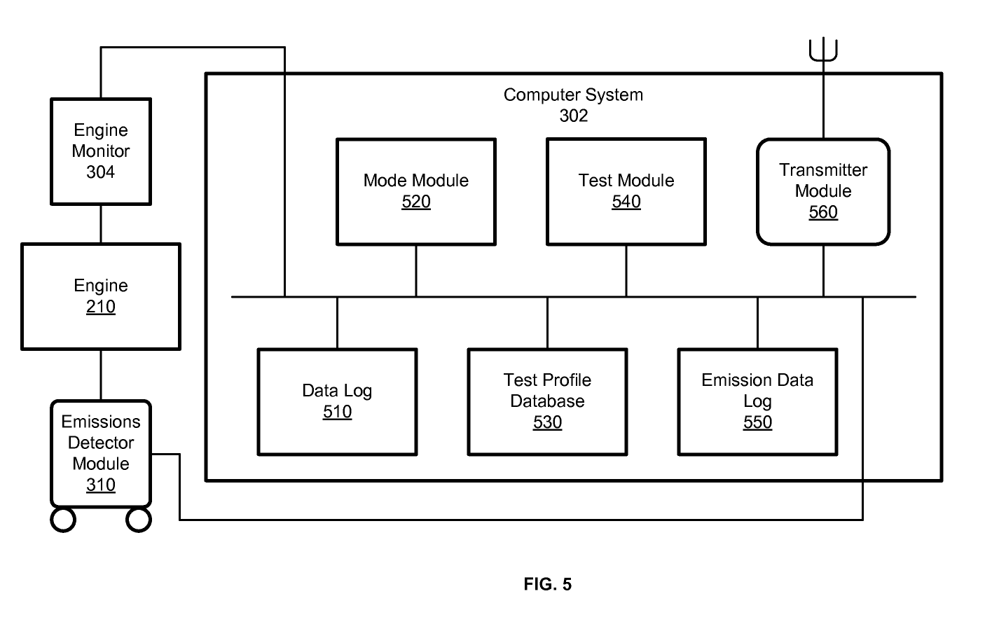

FIG. 5 is a block diagram illustrating details of the computer system 302 of FIG. 3. The computer system 302 of FIG. 5 includes a data log 510, a mode module 520, a test profile database 530, a test module 540, an emission data log 550, and an optional transmitter module 560. The data log 510 is configured to receive a stream of engine data from the engine monitor 304 and store the data. The mode module 520 is configured to analyze the data in the data log 510 and use the analysis to determine a test mode definition for the engine 210. The test profile database 530 is configured to store a test profile and the test mode definition determined by the mode module 520. The test module 540 is configured to analyze the stream of engine data in the data log 510 to determine if the engine 210 is in a steady-state. The test module 540 is further configured to compare the test mode definition in the test profile database 530 to the stream of data in the data log 510 to determine if the engine 210 is operating in a test mode. The test module 540 may execute the test profile in the test profile database 530 when the engine is in a steady-state and a test mode. The emission data log 550 is configured to receive emissions data from the emissions detector module 310.

The transmitter module 560 is a software and/or hardware interface configured to provide communication between the computer system 302 and another computer system, such as a shore based computer system. The transmitter module 560 may also provide communication between the computer system 302 and the engine monitor 304 and/or the emissions detector module 310. The transmitter module 560 may receive engine data from detectors disposed on the engine 210. Various modes of communication via the transmitter module 560 include wireless, infrared, intranet, internet, LAN, WAN, satellite, optical fiber, cell, ship to shore, ship to ship, and etc.

While the data log 510, mode module 520, test profile database 530, test module 540, emission data log 550, and transmitter module 560 are illustrated as part of a single computer, these modules may be distributed among multiple computers that collectively comprise computer system 302. For example, the transmitter module 560 may be configured to transmit engine data and emission data to between computers, including a shore based computer system (not illustrated), for storage in a data log 510, and emission data log 550, respectively in the shore base computer system.

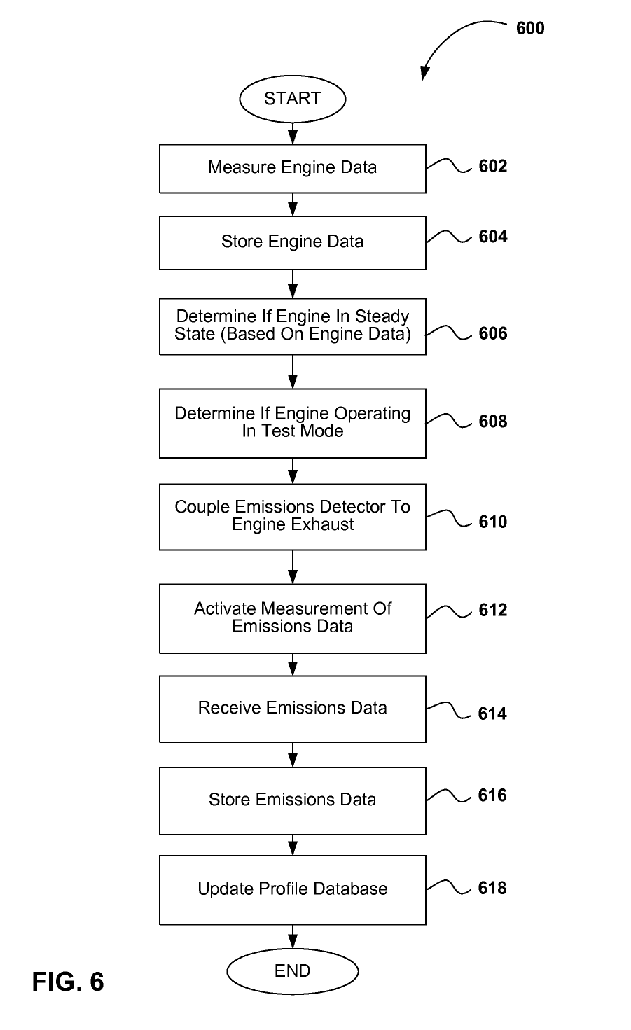

FIG. 6 is a flow diagram of an exemplary process 600 for monitoring emissions from an engine 210. In step 602, engine data is monitored (e.g., using the engine monitor 304). In step 604, the monitored engine data is stored in the computer system 302 (e.g., in the data log 510). In step 606, the computer system 302 uses stored engine data to determine if the engine is operating in a steady state. Optionally, the computer system 302 uses accelerometer data (e.g., from the engine, the engine manifold, emissions control, the engine monitor, and/or emissions detector) to determine if the engine is operating in a steady state. In step 608, the computer system 302 (e.g., the test module 540 or the mode module 520) compares the monitored engine data to a test mode definition in the test profile database 530 to determine if the engine is operating within a test mode. Optionally, the computer system 302 uses accelerometer data from the engine manifold, emissions control, and/or emissions detector module 310 determine if the engine 210 is operating within a test mode.

In step 610, one or more detectors (e.g., emissions detectors 410-450) in the emissions detector module 310 are fluidly coupled to the engine exhaust gas when the engine 210 is in a steady-state and/or in a test mode. In step 612, one or more detectors in the emissions detector module 310 are activated while the engine 210 is operating within the test mode at a steady state. In step 614, the computer system 302 receives data from the one or more activated emissions representing emissions in the engine exhaust gas during the steady-state. In step 616, the emissions data is stored (e.g., in the in the emission data log 550 of the computer system 302). The steps 610-616 may be repeated multiple times for a particular test mode during normal operations of the engine 210. The emission data may be aggregated for the test mode to provide an average of emissions and a trend for the emissions in that test mode.

Multiple test modes may be defined for the engine 210. The steps 610-616 may be repeated multiple times for each defined test modes during normal operations of the engine 210. The emission data for each of the defined test modes may be aggregated. The aggregated emission data may provide an average emission and a trend for the emissions for each of the test modes.

In step 618, the test mode definition in the test profile database 530 is updated based on the monitored engine data. The mode module 520 may determine a new test mode definition based on an analysis of the engine data and provide the new definition to the test profile database 530. Steps 610-618 may be repeated multiple times and the test mode definition may be modified multiple times. Each of multiple test mode definitions may be modified multiple times.

Several embodiments are specifically illustrated and/or described herein. However, it will be appreciated that modifications and variations are covered by the above teachings and within the scope of the appended claims without departing from the spirit and intended scope thereof. For example, the engine systems 200, 240, and 250 are described for a ship, however, these systems may be used for other applications, including power plants, land vehicles, aircraft, and etc. Various embodiments of the invention include logic stored on computer readable media, the logic configured to perform methods of the invention.

The embodiments discussed herein are illustrative of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A method for monitoring emissions from an engine onboard a ship, the method comprising:
monitoring engine data using a computer system;
storing the monitored engine data in the computer system;
determining if the engine is operating in a steady-state using the computer system based on the stored engine data;
determining if the engine is operating within a test mode based on a comparison of the monitored engine data and a test mode definition in a test profile database;
coupling an emissions detector fluidly to the engine exhaust gas based on the steady-state determination and the test mode determination;
activating the coupled emissions detector based on the test profile data, while the engine is operating within the test mode;
receiving in the computer system emissions data from the emissions detector representing emissions in the engine exhaust gas during the steady-state;
updating the test mode definition in the test profile database based on the monitored engine data; and
storing the emissions data in the computer system.

2. The method of claim 1, wherein the monitored engine data used for determining if the engine is operating in a test mode include engine output power and load on the engine.

3. The method of claim 1, further comprising un-coupling the emissions detector from the engine exhaust gas if the engine is not in a steady-state.

4. The method of claim 1, wherein the stored emissions data comprises data representing measurements of carbon monoxide, carbon dioxide, oxygen, hydrocarbons, non-methane hydrocarbons, oxides of nitrogen, sulphur dioxide, ammonia, dinitrogen oxide, formaldehyde, methanol, and particulate matter.

5. The method of claim 1, wherein the emissions data represent emissions upstream of an emissions control system and downstream of the emissions control system.

6. The method of claim 1, wherein engine data comprises rotations per minute of the engine, power output of the engine, torque on the engine, exhaust temperature, exhaust pressure, compressor air input temperature, compressor air input pressure, compressor air output temperature, compressor air output pressure, turbine air output temperature, turbine air output pressure, turbine torque, or turbine rotations per minute.

7. The method of claim 1, further comprising transmitting the stored engine data to a shore based computer system.

8. The method of claim 1, further comprising transmitting the updated profile data to a shore based computer system.

9. A system for monitoring engine exhaust gas emissions, the system comprising:
an engine monitor configured to receive a stream of engine data from engine sensors during normal operations of the engine;
an engine data log configured to store the stream of engine data from the engine monitor;
an emissions detector module configured for fluid coupling and un-coupling under computer control to the engine exhaust gas, the emissions detector module including sensors configured for measuring the engine exhaust gas emissions;
an emissions data log configured to store measured emissions data from the emissions detector module;
a test profile database configured to store an emission test profile and a test mode definition; and
a computer system coupled to the engine monitor and the emissions detector module, the computer system configured to:
determine if the engine is in a steady-state based on the stream of engine data,
determine if the engine is operating within the test mode based on a comparison of the test mode definition to the stream of engine data,
couple the emissions detector module to the engine exhaust gas for execution of the emission test profile when the engine is operating within the test mode,
modify the test mode definition using the stream of engine data.

10. The system of claim 9, further comprising a transmitter configured to communicate data between the computer system and a shore based receiver.

11. The system of claim 9, further comprising a valve under control of the computer system, the valve configured to fluidly couple and uncouple the emissions detector module to exhaust gas from two or more of a plurality of engines.

12. The system of claim 11, wherein the computer system is configured to select the at least one of a plurality of engines based on the stream of engine data.

13. The system of claim 9, wherein the emissions detector module includes a heater under control of the computer system, the heater configured to heat exhaust gas received from the engine.

14. The system of claim 9, wherein the stream of engine data includes a rotation rate of the engine, a power output of the engine, a torque on a drive shaft of the engine, or a load on the engine.

15. The system of claim 9, wherein the stream of engine data includes pressure data representing a pressure of exhaust gas from the engine, a pressure of intake gas between the engine and a compressor, ambient pressure at the intake of the compressor, or pressure of exhaust gas output from a turbine.

16. The system of claim 9, wherein the stream of engine data includes temperature data representing a temperature of exhaust gas from the engine, a temperature of intake gas between the engine and a compressor, ambient temperature at the intake of the compressor, or temperature of exhaust gas output from a turbine.

17. An emissions detector system for monitoring engine exhaust gas emissions onboard a ship, the system comprising:
a computer system;
a valve under control of the computer system and configured to couple the emissions detector system selectively to exhaust gas from either a first engine or a second engine;
a heater under control of the computer system and configured to heat the engine exhaust gas;
a compressor configured to maintain the exhaust gas at a target pressure;
an orifice array configured to receive exhaust gas from the compressor and control the flow rate of a stream of exhaust gas;
an emission sensor configured to receive the controlled stream of exhaust gas from the orifice array and to measure emissions in the exhaust gas; and
an accelerometer configured to detect motion of the emissions detector system, the computer system configured to suspend measurement of the emissions in the exhaust gas based on detection of excessive acceleration of the emissions detector system.

18. The system of claim 17, further comprising a transceiver coupled to the computer system, the transceiver configured to communicate measured data to another computer system.

19. The system of claim 17, further comprising a transceiver coupled to the computer system, the transceiver configured to receive measurement data from an accelerometer coupled to an exhaust manifold.

20. The system of claim 17, wherein the emission sensor comprises a NOx sensor configured to measure oxides of nitrogen, a COx sensor configured to measure oxides of carbon, an O₂ sensor configured to measure oxygen, a HC sensor configured to measure hydrocarbons, or a PM sensor configured to measure particulate matter.
